(19) United States
(12) Patent Application Publication
(10) Pub. No.: US 2007/0084468 A1
(43) Pub. Date: Apr. 19, 2007

(54) MO O2 Mask

(76) Inventor: Ryan Steven Schafer, Edmond, OK (US)

Correspondence Address: RYAN SCHAFER, 2405 HANOVER LANE, EDMOND, OK, 73034, US

(21) Appl. No.: 11/163,406

(22) Filed: Oct. 18, 2005

(51) Int. Cl. A62B 18/02

(52) U.S. Cl. 128/206.21; 128/206.28

(57) ABSTRACT

The MO Oxygen mask is a new and improved design of the traditional Oxygen mask used universally for medical and emergency purposes. The simple modification of the MO Oxygen mask will allow greater comfort to patients and greater ease of use by the practitioner. The modification is to create flap near the bottom of the mask the can snap open or close to allow easier insertion of tubes that may be needed to be inserted in the patients nose or mouth. This modification will more comfort to the patients, who often develop sore from the tube being forced down and held or taped into position. This modification will also make the practitioners job easier by not having to tape or finagle the oxygen mask and tubes into position.

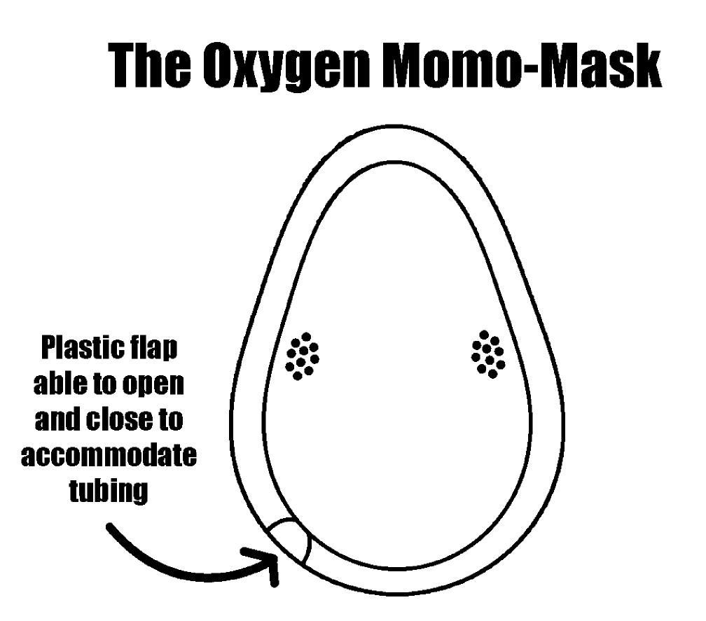

Modifications to traditional/existing oxygen mask used for medical procedures

What is claimed is:

1. The MO Oxygen mask is a simple new design to the existing oxygen masks used in everyday medical procedures, the modifications will provide comfort to the patient and will be easier to administer for the medical professionals providing care to the patient.
